(19) United States
(12) Patent Application Publication
(10) Pub. No.: US 2017/0158025 A1
(43) Pub. Date: Jun. 8, 2017

(54) HEATING, VENTILATION, AIR CONDITIONING AND REFRIGERATION SYSTEM WITH DEHUMIDIFICATION

(71) Applicant: Carrier Corporation, Jupiter, FL (US)

(72) Inventor: Bart Antonie van Hassel, Weatogue, CT (US)

(21) Appl. No.: 15/364,587

(22) Filed: Nov. 30, 2016

Related U.S. Application Data
(60) Provisional application No. 62/262,030, filed on Dec. 2, 2015.

(51) Int. Cl. B60H 1/32; B60H 3/02; B60H 1/00

(52) U.S. Cl. CPC B60H 1/323; B60H 1/00392; B60H 3/024; B60H 1/3201; B60H 1/3227; B60H 2001/3291

(57) ABSTRACT

A heating, ventilation, air conditioning and refrigeration (HVAC/R) system includes a cooling circuit including an evaporator to exchange thermal energy between a primary refrigerant flow and a secondary refrigerant flow reducing a temperature of the secondary refrigerant flow, a cooling heat exchanger to exchange thermal energy between the secondary refrigerant flow and an airflow through the cooling heat exchanger to reduce a temperature of the airflow, and a drain to remove condensate. A reheat circuit is located downstream of the cooling heat exchanger including an adsorber heat exchanger to adsorb the primary refrigerant flow, generating thermal energy. The generated thermal energy is transferred to a reheat refrigerant flow through the adsorber heat exchanger. A reheat heat exchanger exchanges thermal energy between the reheat refrigerant flow and the airflow to increase the temperature of the airflow, thereby lowering the relative humidity of the airflow.

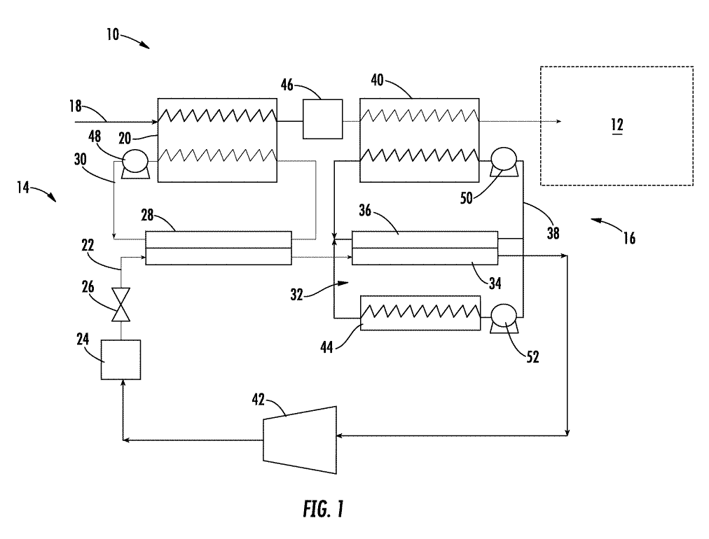

### CROSS REFERENCE TO RELATED APPLICATIONS

This application claims the benefit of an earlier filing date from U.S. Provisional Application Ser. No. 62/262,030 filed Dec. 2, 2015, the entire disclosure of which is incorporated herein by reference.

### BACKGROUND

The subject matter disclosed herein relates to heating, ventilation, air conditioning and refrigeration (HVAC/R) systems. More specifically, the subject matter disclosed herein relates to dehumidification of cooling air of HVAC/R systems.

In HVAC/R systems for, for example, home or commercial applications, or for transportation vehicles or the like, an airflow is passed over a cooling coil through which a flow of refrigerant is circulated. The cooled airflow is then flowed into the cabin or other space to be cooled. Moisture condenses onto the cooling coil and is picked up as condensate droplets by the airflow as the airflow passes over the cooling coil. The resulting fog is undesirable. Fog formation can be prevented by separating the condensate and reheating the airflow to more comfortable levels. In a typical application, such as an internal combustion engine powered automobile, engine heat is utilized to reheat the airflow. In other applications such as electrically-powered vehicles, however, engine heat is not available, and energy stored in the vehicle's battery must be used to power the reheating operation. Use of the battery power for reheat reduces the vehicle's range.

### BRIEF SUMMARY

In one embodiment, a heating, ventilation, air conditioning and refrigeration (HVAC/R) system includes a cooling circuit to reduce a temperature of an airflow. The cooling circuit includes an evaporator configured to exchange thermal energy between a primary refrigerant flow and a secondary refrigerant flow reducing a temperature of the secondary refrigerant flow, a cooling heat exchanger configured to exchange thermal energy between the secondary refrigerant flow and an airflow through the cooling heat exchanger to reduce a temperature of the airflow, and a drain to remove condensate. The system further includes a reheat circuit located downstream of the cooling heat exchanger relative to a flow direction of the airflow to reduce the relative humidity of the airflow. The reheat circuit includes an adsorber heat exchanger including a volume of adsorber material to adsorb the primary refrigerant flow, generating thermal energy at the adsorber heat exchanger. The generated thermal energy is transferred to a reheat refrigerant flow through the adsorber heat exchanger. The reheat circuit further includes a reheat heat exchanger in thermal communication with the airflow and with the reheat refrigerant flow configured to exchange thermal energy between the reheat refrigerant flow and the airflow to increase the temperature of the airflow, thereby lowering the relative humidity of the airflow.

Additionally or alternatively, in this or other embodiments the primary refrigerant flow comprises ammonia.

Additionally or alternatively, in this or other embodiments the adsorber material is a salt.

Additionally or alternatively, in this or other embodiments the adsorber material is one of strontium chloride or barium chloride.

Additionally or alternatively, in this or other embodiments the adsorber material has an adsorber vapor pressure lower than a refrigerant vapor pressure of the primary refrigerant flow.

Additionally or alternatively, in this or other embodiments a condenser is in flow communication with the adsorber heat exchanger to regenerate the primary refrigerant flow from the adsorber material.

Additionally or alternatively, in this or other embodiments a refrigerant compressor is in flow communication with the adsorber heat exchanger and the condenser to compress the primary refrigerant flow.

Additionally or alternatively, in this or other embodiments an ambient heat exchanger is in thermal communication with the adsorber heat exchanger to reject excess thermal energy to ambient.

In another embodiment, a method of operating a heating, ventilation and air conditioning (HVAC/R) system includes urging a primary refrigerant flow to an evaporator, exchanging thermal energy between the primary refrigerant flow and a secondary refrigerant flow at the evaporator and exchanging thermal energy between the secondary refrigerant flow and an airflow at a cooling heat exchanger, thereby reducing a temperature of the airflow. Condensate is removed by a drain. The primary refrigerant flow is flowed from the evaporator to an adsorber heat exchanger including a volume of an adsorber material and the primary refrigerant flow is adsorbed into the adsorber material thus generating thermal energy at the adsorber heat exchanger. The generated thermal energy is transferred to a reheat refrigerant flow at the adsorber heat exchanger and thermal energy is transferred from the reheat refrigerant flow to the airflow at a reheat heat exchanger located downstream from the cooling heat exchanger relative to a direction of the airflow, thereby increasing the temperature of the airflow and reducing the relative humidity thereof.

Additionally or alternatively, in this or other embodiments the airflow is directed from the reheat heat exchanger to a conditioned space.

Additionally or alternatively, in this or other embodiments the primary refrigerant flow comprises ammonia.

Additionally or alternatively, in this or other embodiments the adsorber material is a salt.

Additionally or alternatively, in this or other embodiments the adsorber material is one of strontium chloride or barium chloride.

Additionally or alternatively, in this or other embodiments the adsorber material has an adsorber vapor pressure lower than a refrigerant vapor pressure of the primary refrigerant flow.

Additionally or alternatively, in this or other embodiments the primary refrigerant flow is flowed from the adsorber heat exchanger to a condenser in flow communication with the adsorber heat exchanger to regenerate the primary refrigerant flow from the adsorber material.

Additionally or alternatively, in this or other embodiments the primary refrigerant flow is compressed at a refrigerant compressor in flow communication with the adsorber heat exchanger and the condenser.

Additionally or alternatively, in this or other embodiments excess thermal energy is rejected to ambient from an ambient heat exchanger in thermal communication with the adsorber heat exchanger.

These and other advantages and features will become more apparent from the following description taken in conjunction with the drawings.

### BRIEF DESCRIPTION OF THE DRAWING

The subject matter is particularly pointed out and distinctly claimed at the conclusion of the specification. The foregoing and other features, and advantages of the present disclosure are apparent from the following detailed description taken in conjunction with the accompanying drawing in which:

The FIGURE is a schematic view of an exemplary heating, ventilation, cooling and refrigeration system.

### DETAILED DESCRIPTION

Shown in The FIGURE is a schematic view an exemplary embodiment of a heating, ventilation, air conditioning and refrigeration (HVAC/R) unit system 10. The HVAC/R system 10 is described in the context of a vehicle, in particular an electrically-powered vehicle, in which the HVAC/R system 10 is utilized to cool a vehicle passenger cabin 12. It is to be appreciated, however, that the system disclosed herein may be utilized in a variety of other applications such as conditioning of residential or commercial buildings or spaces, transportation refrigeration units, or refrigerated display cases.

The HVAC/R system 10 includes a cooling circuit 14 and a reheat circuit 16. The cooling circuit 14 acts to cool an airflow 18 and condense moisture from the airflow 18 to condition the passenger cabin 12, while the reheat circuit 16 acts to reheat the airflow 18 prior to the airflow 18 entering the passenger cabin 12. The reheated airflow 18 is at a more comfortable temperature for passengers in the passenger cabin 12, and has a lower relative humidity since the condensed moisture has been drained from the airflow 18, allowing the airflow 18 to be capable of absorbing moisture from the passengers.

The cooling circuit 14 includes a cooling heat exchanger 20 to cool the airflow 18 entering the cooling heat exchanger 20. The cooling circuit 14 is driven by a primary refrigerant flow 22, in some embodiments an ammonia, NH₃. The primary refrigerant 22, as a liquid, flows from condenser 24 through expansion device 26 and into evaporator 28. At the evaporator 28, thermal energy is exchanged between the primary refrigerant flow 22 and a secondary refrigerant flow 30, for example, R410A, cooling the secondary refrigerant flow 30. The secondary refrigerant flow 30 is then circulated to the cooling heat exchanger 20, in some embodiments via recirculation pump 48, where the airflow 18 is cooled via thermal energy exchange between the secondary refrigerant flow 30 and the airflow 18. The secondary refrigerant flow 30 then proceeds back to the evaporator 18 for recooling via thermal energy exchange with the primary refrigerant flow 22. Water vapor in the airflow 18 condenses at the cooling heat exchanger 20, and is drained from the airflow 18 at a drain 46.

The cooled airflow 18 may feel too cold for passenger comfort, and may have a higher than desired relative humidity, a ratio of water vapor present in the airflow 18 to an amount of water vapor the airflow 18 can hold at a given temperature. To bring the airflow 18 to a more comfortable temperature and to lower the relative humidity of the airflow 18 before the airflow enters the passenger cabin 12, the cooled airflow 18 is reheated to a selected temperature at the reheat circuit 16.

The reheat circuit 16 includes a refrigerant adsorber heat exchanger 32 into which gaseous primary refrigerant flow 22 is directed after flowing through the evaporator 28. The refrigerant adsorber heat exchanger 32 includes an adsorber portion 34 and a heat exchanger portion 36, with the primary refrigerant flow 22 directed into the adsorber portion 34 where an adsorber material adsorbs the gaseous primary refrigerant 22, emitting thermal energy. In some embodiments, the adsorbant material is a metal chloride salt, such as strontium chloride or barium chloride. The adsorber material is chosen to provide a desired amount of heating during adsorption, while minimizing an amount of energy that must be added to the system to regenerate the primary refrigerant flow 22. Further, a vapor pressure of the primary refrigerant flow 22 is greater than the pressure of the primary refrigerant in equilibrium with the adsorber material so the pressure differential draws the primary refrigerant flow 22 through the evaporator 28 and toward the adsorber heat exchanger 32. The resulting HVAC/R system 10 uses minimal power while driving due to the use of the primary refrigerant adsorption process.

A reheat refrigerant flow 38 circulates between a reheat heat exchanger 40 and the heat exchanger portion 36 of the adsorber heat exchanger 32 via, in some embodiments, recirculation pump 50. In some embodiments, the reheat refrigerant flow 38 is an R410A refrigerant. Thermal energy from the adsorption process is transferred to the reheat refrigerant flow 38 at the heat exchanger portion 36, and the warmed reheat refrigerant flow 38 is directed back to the reheat heat exchanger 40, where the airflow 18 is warmed via thermal energy exchange with the reheat refrigerant flow 38. Warming of the airflow 18 at the reheat heat exchanger 40 increases a temperature of the airflow 18 and consequently lowers the relative humidity of the airflow 18, thereby further conditioning the airflow 18 which is then directed to the passenger cabin 12 to cool the passenger cabin 12 before being circulated back to the cooling heat exchanger 20. Under certain operating conditions, reheat of the airflow 22 is not needed to achieve the desired relative humidity, so thermal energy generated by the absorption process is rejected to ambient by directing the reheat refrigerant flow 38 to an ambient heat exchanger 44 via recirculation pump 52.

To maintain operation of the HVAC/R system 10, the primary refrigerant flow 22 is regenerated from the adsorber portion 34. To regenerate the primary refrigerant flow 22, the adsorber portion 34 is heated to release the primary refrigerant flow 22 vapor from the adsorber material. The primary refrigerant flow 22 is then routed from the adsorber portion 34 through refrigerant compressor 42 and to condenser 24 where liquid primary refrigerant flow 22 is collected. In some embodiments, the energy required to heat the adsorber portion 34 during regeneration is provided during charging of an electrical battery of the vehicle, e.g. while plugged into an electrical grid.

The HVAC/R system 10 utilizes minimal electrical power during vehicle operation, as the primary refrigerant flow 22 evaporates by absorbing thermal energy from the secondary refrigerant flow 30, and the adsorbant material adsorbs the primary refrigerant flow 22 while rejecting the heat of adsorption to the reheat heat exchanger 40 or to ambient via the ambient heat exchanger 44. The HVAC/R system 10 disclosed herein provides for dehumidification of the airflow 18 by using readily available thermal energy from the adsorption process that requires lower energy input than traditional systems, which is especially advantageous in electrically powered vehicles where electrical power traditionally used for reheat of the airflow drains reserves from the battery system powering the vehicle. Thus, the HVAC/R system 10 extends battery life of the vehicle extending its operating range.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A heating, ventilation, air conditioning and refrigeration (HVAC/R) system comprising:
a cooling circuit to reduce a temperature of an airflow including:
an evaporator configured to exchange thermal energy between a primary refrigerant flow and a secondary refrigerant flow reducing a temperature of the secondary refrigerant flow;
a cooling heat exchanger configured to exchange thermal energy between the secondary refrigerant flow and an airflow through the cooling heat exchanger to reduce a temperature of the airflow; and
a drain to remove condensate; and
a reheat circuit disposed downstream of the cooling heat exchanger relative to a flow direction of the airflow to reduce the relative humidity of the airflow, the reheat circuit including:
an adsorber heat exchanger including a volume of adsorber material to adsorb the primary refrigerant flow, generating thermal energy at the adsorber heat exchanger, the generated thermal energy transferred to a reheat refrigerant flow through the adsorber heat exchanger; and
a reheat heat exchanger in thermal communication with the airflow and with the reheat refrigerant flow configured to exchange thermal energy between the reheat refrigerant flow and the airflow to increase the temperature of the airflow, thereby lowering the relative humidity of the airflow.

2. The HVAC/R system of claim 1, wherein the primary refrigerant flow comprises ammonia.

3. The HVAC/R system of claim 1, wherein the adsorber material is a salt.

4. The HVAC/R system of claim 3, wherein the adsorber material is one of strontium chloride or barium chloride.

5. The HVAC/R system of claim 1 wherein the adsorber material has an adsorber vapor pressure lower than a refrigerant vapor pressure of the primary refrigerant flow.

6. The HVAC/R system of claim 1, further comprising a condenser in flow communication with the adsorber heat exchanger to regenerate the primary refrigerant flow from the adsorber material.

7. The HVAC/R system of claim 1, further comprising a refrigerant compressor in flow communication with the adsorber heat exchanger and the condenser to compress the primary refrigerant flow.

8. The HVAC/R system of claim 1, further comprising an ambient heat exchanger in thermal communication with the adsorber heat exchanger to reject excess thermal energy to ambient.

9. A method of operating a heating, ventilation and air conditioning (HVAC/R) system comprising:
urging a primary refrigerant flow to an evaporator;
exchanging thermal energy between the primary refrigerant flow and a secondary refrigerant flow at the evaporator;
exchanging thermal energy between the secondary refrigerant flow and an airflow at a cooling heat exchanger, thereby reducing a temperature of the airflow;
removing condensate by a drain;
flowing the primary refrigerant flow from the evaporator to an adsorber heat exchanger including a volume of an adsorber material;
adsorbing the primary refrigerant flow into the adsorber material thus generating thermal energy at the adsorber heat exchanger;
transferring the generated thermal energy to a reheat refrigerant flow at the adsorber heat exchanger; and
transferring thermal energy from the reheat refrigerant flow to the airflow at a reheat heat exchanger located downstream from the cooling heat exchanger relative to a direction of the airflow, thereby increasing the temperature of the airflow and reducing the relative humidity thereof.

10. The method of claim 9, further comprising directing the airflow from the reheat heat exchanger to a conditioned space.

11. The method of claim 9, wherein the primary refrigerant flow comprises ammonia.

12. The method of claim 9, wherein the adsorber material is a salt.

13. The method of claim 12, wherein the adsorber material is one of strontium chloride or barium chloride.

14. The method of claim 9 wherein the adsorber material has an adsorber vapor pressure lower than a refrigerant vapor pressure of the primary refrigerant flow.

15. The method of claim 9, further flowing the primary refrigerant flow from the adsorber heat exchanger to a condenser in flow communication with the adsorber heat exchanger to regenerate the primary refrigerant flow from the adsorber material.

16. The method of claim 9, further comprising compressing the primary refrigerant flow at a refrigerant compressor in flow communication with the adsorber heat exchanger and the condenser.

17. The method of claim 9, further comprising rejecting excess thermal energy to ambient from an ambient heat exchanger in thermal communication with the adsorber heat exchanger.
